(19) United States
(12) Patent Application Publication
(10) Pub. No.: US 2010/0306214 A1
(43) Pub. Date: Dec. 2, 2010

(54) IDENTIFYING MODIFIERS IN WEB QUERIES OVER STRUCTURED DATA

(75) Inventors: Stelios Paparizos, San Jose, CA (US); Amrula Sadanand Joshi, Los Angeles, CA (US); Lise C. Getoor, Takoma Park, MD (US); Alexandros Ntoulas, Mountain View, CA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/473,286

(22) Filed: May 28, 2009

(51) Int. Cl. G06F 17/30

(52) U.S. Cl. 707/759; 704/270; 704/10; 707/805; 707/754

(57) ABSTRACT

Described is using modifiers in online search queries for queries that map to a database table. A modifier (e.g., an adjective or a preposition) specifies the intended meaning of a target, in which the target maps to a column in that table. The modifier thus corresponds to one or more functions that determine which rows of data in the column match the query, e.g., “cameras under $400” maps to a camera (or product) table, and “under” is the modifier that represents a function (less than) that is used to evaluate a “price” target/data column. Also described are different classes of modifiers, and generating the dictionaries for a domain (corresponding to a table) via query log mining.

### BACKGROUND

In commercial web search today, users typically submit short queries, which are then matched against a large data store. Often, a simple keyword search does not suffice to provide desired results, as many words in the query have semantic meaning that dictates evaluation. Consider for example a query such as “digital camera around $425”. Performing a plain keyword match over documents will not produce matches for cameras priced at $420 or $430, and so forth. Such words appear quite often in queries, in various forms, and are context dependent, e.g., “fast zoom lens”, “latin dance shoes”, “used fast car on sale near san francisco” (note that capitalization and punctuation within example queries herein are not necessarily correct so as to match what users normally input).

At the same time, there are words in the query that do not offer anything with respect to the evaluation and relevance of results. For example, a query such as “what is the weather in seattle today” seeks the same results as the query “weather in seattle today”; the phrase “what is” becomes inconsequential, whereas “today” has a meaning that affects the evaluation.

In general, improved search results may be provided if the user's intent with respect to various words with in queries was able to be discerned. Any technology that provides improved search results is desirable.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which a query log is processed to determine modifiers (e.g., certain words) within the queries that provide information regarding targets, in which each target corresponds to a subset (e.g., a column) of structured data (e.g., a table). In online query processing, the modifier for each target is used to evaluate the data within that subset. For example a modifier (e.g., “less than”) is used to determine which rows of data in the column match the target.

In one aspect, the modifiers are maintained as a set of dictionaries for each domain (table). The dictionaries may be generated by filtering the query log to obtain a subset of queries that correspond to the domain. The modifier dictionaries may also be provided manually to the online system, such as by a domain expert, for example. Each query in the subset is annotated to find candidate modifiers for that query, with features determined for each candidate modifier. Features may include a token part of speech feature and a token semantics feature, and context features such as based upon usage frequency of the candidate modifier with respect to other words in the queries, and an ordering of the candidate modifier with respect to other words in the queries. The modifiers may be clustered into the dictionaries based upon similarities between candidate modifiers; some modifiers may be filtered out of the dictionary, e.g., based upon low frequency.

In one aspect, the modifiers may be classified in various ways based on their characteristics, such as the role they play in data retrieval. A dangling modifier corresponds to a target that is not identified within the query, whereas an anchored modifier corresponds to a target that is identified within the query. A subjective modifier has a plurality of possible functions that describe the operations for mapping (e.g., for evaluating a data column for a target), while an objective modifier has a single function. An unobserved objective modifier (in contrast to an observed objective modifier) is a modifier that is in a query but does not have data in a data column for a target.

Online processing of a query determines, for a table to which that query maps, whether the query includes a modifier of a target that corresponds to a column of that table. If so, the table is accessed, and the column data evaluated based upon the modifier to return results for the query from the table. The dictionaries may be accessed to determine whether the query includes a modifier. Queries that do not map to a table or do not contain a modifier may be provided to a conventional search engine.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram representing example components for offline generating dictionaries of modifiers.

FIG. 2 is a block diagram representing example components for online processing of a query by accessing modifier dictionaries to query structured data.

FIG. 3 is a representation of different classes of modifiers.

FIG. 4 is a flow diagram showing example steps used in generating modifier dictionaries

FIG. 5 is a representation showing semantic similarity between words in hyponym graphs.

FIG. 6 shows an illustrative example of a computing environment into which various aspects of the present invention may be incorporated.

### DETAILED DESCRIPTION

Various aspects of the technology described herein are generally directed towards identifying words that have certain meanings in a query that alter (“modify”) the execution over data, and distinguish between such words over inconsequential ones. As used herein, the words that alter the meaning of a query are referred to herein as “modifiers”, while those that are inconsequential with respect to queries are referred to as “inconsequential tokens.” In general, modifiers modify “data tokens”. When processing a query, such modifiers may be annotated to process the query against structured or semi-structured data in a way that provides results that are more likely to match the user's intent. In other words, as described below, using modifiers, the query may be mapped to structured or semi-structured data, e.g., a database table and one or more columns in that table.

In one aspect, such online annotation is accomplished by (offline) data mining over query logs to identify modifiers in combination with some part of speech annotation. Patterns are constructed from the logs where groups of words appear next to each other, and analyzed to determine statistical significance indicating that a certain type of word appears next to some known data token (e.g., “around”, “in” or “under” appearing next to a numeric value).

It should be understood that any of the examples herein are non-limiting examples. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and search/query processing in general.

Turning to some of the terminology used herein, the various components of a query (referred to as “TokenClasses”) may be defined based on the role they play. A token is a sequence of characters, and a TokenClass (TC) is a dictionary of tokens that play a similar role in the query. For example, in a query “popular digital camera under $400”, the words “digital camera” belong to a <product> TokenClass, the term “$400” belongs to a <price> TokenClass, and the words “popular” and “under” belong to a <modifier> TokenClass.

A TokenClass may be a described as a set of tokens or by a deterministic function such as regular expressions. For example, a TokenClass for all electronic products may be described as a set as

<product>={‘digital camera’, ‘cell phone’, ‘media player’}.

A TokenClass for price may be described as a regular expression, as,

<price>=$\d+[.\d\d]?

where \d is a digit, + denotes the matching of at least one digit, and ? denotes matching 0 or 1 times.

TokenClasses for search queries may be classified into Universal TokenClasses, Data Driven Token Classes and Modifier Token Classes. Universal TokenClasses are TokenClasses which are deterministically described by a generic mechanism. For example, <number>, <date>, <time>, <location>, <price> are Universal TokenClasses for commercial product searches. These represent components which are generic in nature and not specific to a certain query topic.

DataDriven TokenClasses are the TokenClasses that represent the known entities in a query. For example, the TokenClasses for <product> and <brand> are DataDriven TokenClasses. They can be generated by looking at the values available in the “<product>” and “<brand>” columns of a given shopping data store. DataDriven TokenClasses are generally specific to the query topic as they are extracted from a coherent data store.

Modifier TokenClasses represent auxiliary tokens that alter how other TokenClasses are processed. For example, <‘around’, ‘under’, ‘above’> are each a Modifier TokenClass describing the price, while <‘best’, ‘cheapest’, ‘popular’> are each a Modifier TokenClass describing the type of deal or other fact for which the user/searcher is looking. For example, in a query ‘popular digital camera under $400’, ‘digital camera’ maps to the <product> DataDriven TokenClass, ‘$400’ maps to the <price> Universal TokenClass, and ‘popular’ and ‘under’ map to the <modifiers> TokenClass.

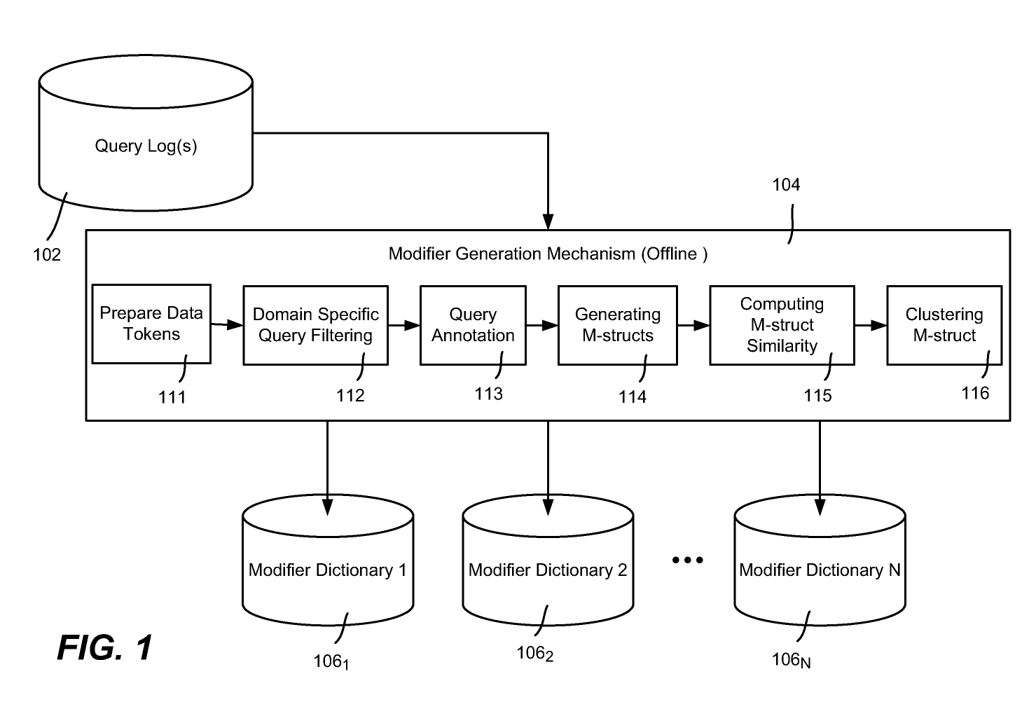

Turning to the drawings, FIG. 1 shows an offline environment that processes one or more query logs 102 via a modifier generation mechanism 104 to create clustered (grouped) lists of modifiers, referred to as dictionaries 106₁-106_{N}. Note that because of the size of data and the web search time requirements (e.g., results need to be available in fewer than 200 ms), an online query analysis solution is problematic; thus the offline creation of the dictionaries is performed in one implementation.

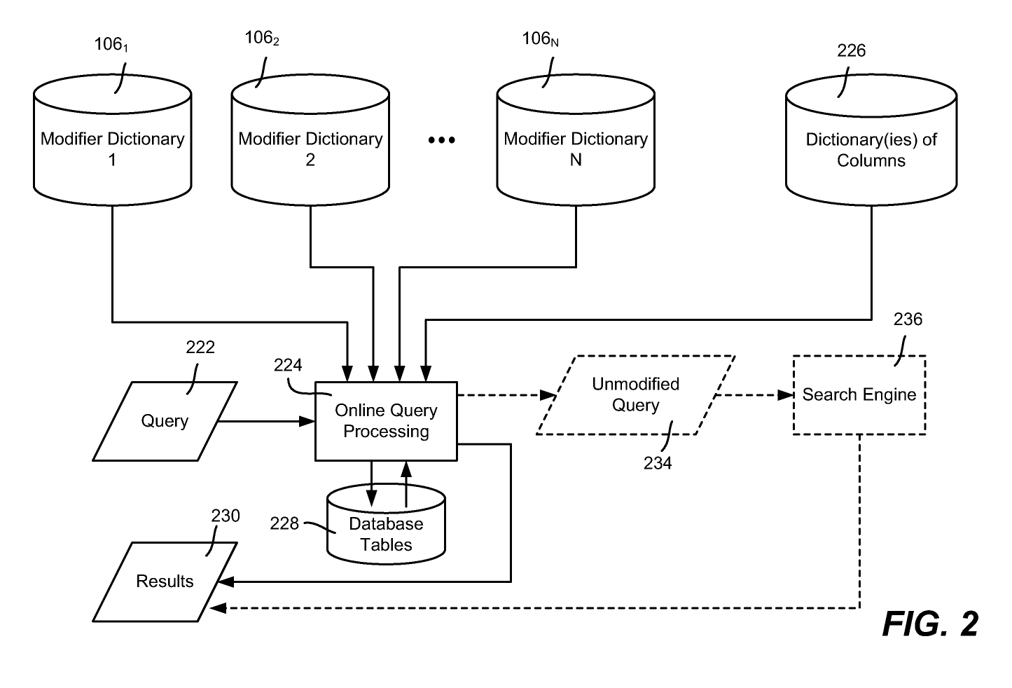

FIG. 2 shows the online processing of an input query 222, which is processed by an online query processing mechanism 224. To this end, and as described below, the online query processing mechanism 224 accesses the modifier dictionaries 106₁-106_{N} and one or more dictionaries of columns 226 to determine whether to modify the query 222 so as to be suitable for querying against a database table 228 or the like; note that one or more words in the query may map the query to a particular table, and other words map the query to that table's underlying data columns. If so, results 230 may be returned from that table and its columns.

Otherwise, as shown for completeness in FIG. 1 by the dashed boxes and lines, other results 230 may be obtained by sending the unmodified query 234 to a search engine 236, e.g., as a conventional query. Note that it is feasible to merge results from a database table access and a search engine.

With respect to database table access, a query may have a target over a table of data, with a modifier having a target over a column of the data table. For example, a query such as “movies after 2007” may correspond to a movie table as a target, with “after” targeting a “year released” column. When processing such a query received online, a “movies” table will be accessed, and the year released column will be accessed to see which rows of the table meet the “after 2007” target criterion. Movie titles within those matched rows may be returned as the results.

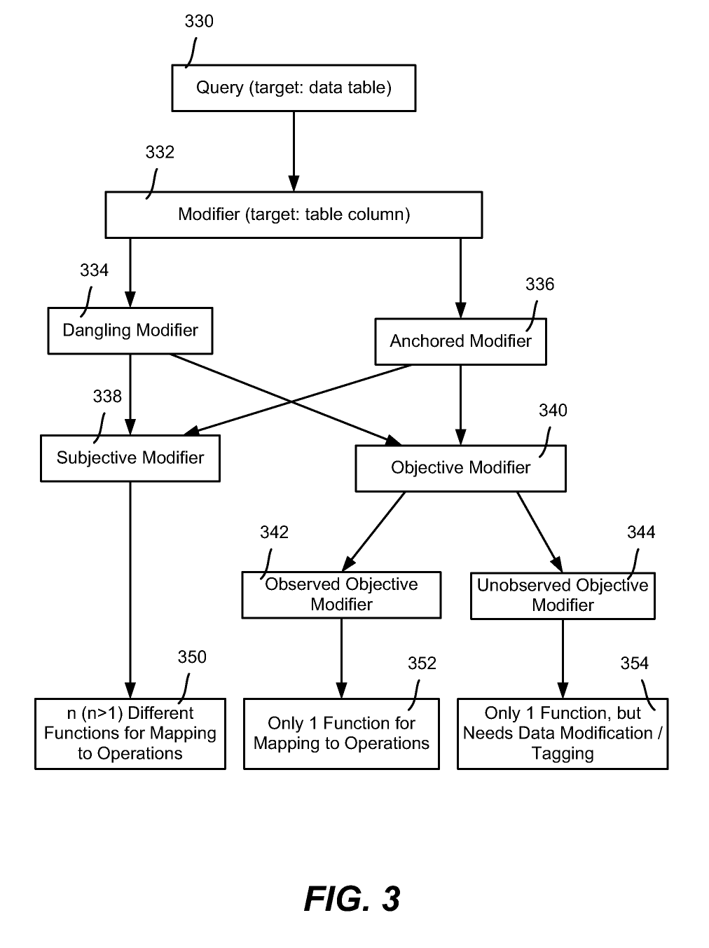

As generally represented in FIG. 3, several classes of modifiers may be used with respect to a query 330 and what the modifier 332 targets for a table and/or a table column. One class is a dangling modifier 334, which comprises a word that modifies the evaluation over a data column not present in the query. By way of example, “cheap camera” modifies the evaluation of a column named price, although no price is present in the query. As another example, “best movies” may be mapped to a movie table, but no column for “best” is present in the query; rather “best” implies a mapping to a ratings column that contains data corresponding to the “best” modifier.

An anchored modifier 336 comprises a word that modifies the evaluation of a data column that is present in the query, By way of example, “camera around $425” is a query in which “around” modifies a price “$425” that is present in the query. Note that an anchored modifier may be adjunct (or not), where adjunct means that the modifier is next to its data column target.

As also represented in FIG. 3, both dangling and anchored modifiers can be further classified. In one implementation, such classifications include subjective modifiers 338 and objective modifiers 340; as described below objective modifiers 340 may be further classified into observed or unobserved objective modifiers 342 and 344, respectively.

For a subjective modifier 338, there exists n different functions (block 350) by which a modifier can alter the evaluation over a given data column; (an alternate way to consider this is that a user-defined function via personalization may be applicable). For example, for “cheap camera” the term “cheap” has many different ways it can be interpreted over price, as one function can be intended by one user to mean lowest price, whereas a different function can be intended by another user to mean largest sale price.

With an objective modifier 340, there exists only one function by which a modifier can map to the target data column and alter its evaluation. For example, “camera under $200” has “under” as a modifier, which only maps to the less than operator (<).

Objective modifiers can be further distinguished into observed and unobserved classes. An objective observed modifier 342 is when the data exists in the underlying table in a format that can be queried clearly (block 352). For example, “camera under $200” is an objective observed modifier, as long as the underlying data table has a price column that is populated, and supports the concept of a less than (<) operation.

An objective unobserved modifier 344 is when the underlying data table does not have the data needed to alter the evaluation in an explicit way and/or does not support an operation. An objective unobserved modifier indicates that information may need to be added to the database; one such indicator may use the form of tagging (block 354). By way of example, consider latin dance shoes” as a query over a “shoes” table. The word “latin” is a modifier. If “latin” exists as a sub-category either explicitly (in a column's data) or implicitly (e.g., shoes that are certain dimensions/color/characteristics as mapped to other columns), then it is an objective observed modifier. However if “latin” does not exist in the data, then it is an objective unobserved modifier and indicates a need to enrich the data to be able to handle such a modifier, if desired.

Returning to FIG. 1, in general, the offline mining process determines which words are modifiers, groups them together in the dictionaries 106₁-106_{N} and associates them with their targets, wherein targets refer to other words in the query that provide context, as found in the query log(s) 102. A general goal of the modifier generation mechanism 104 is to generate the dictionaries 106₁-106_{N} of the modifiers, which are used in identifying different parts of a query for query translation.

As represented in FIG. 1, modifier mining using the query logs 102 comprises a number of stages 111-116. More particularly, the stages are directed towards preparing data tokens (block 111), domain specific query filtering (block 112), query annotation (block 113), generating M-structs (block 114), computing M-struct similarity (block 115) and clustering M-struct (block 116). Each of these stages is described below.

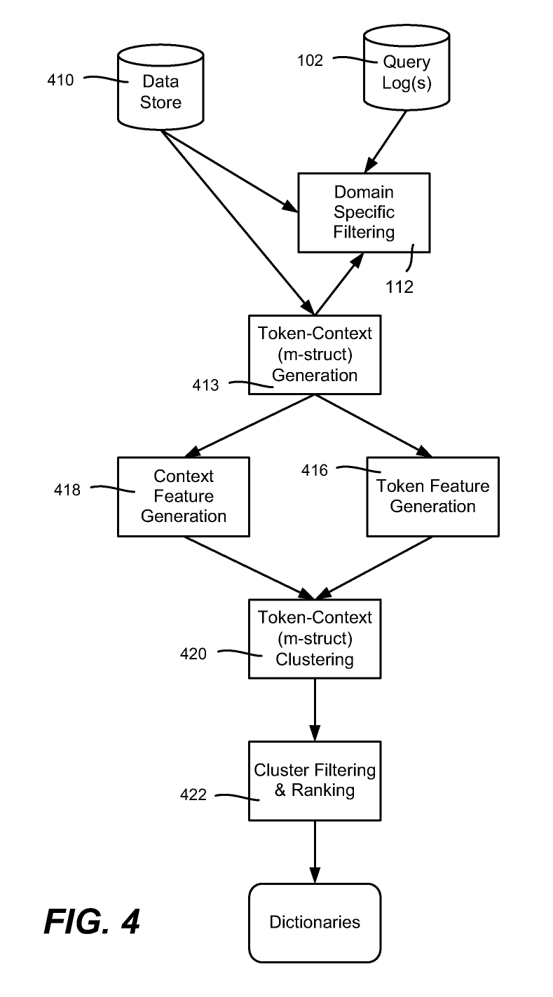

With respect to preparing data tokens, a list of known data tokens related to a domain is obtained by extracting the values from a structured data store 410 (FIG. 4). For example, the MSN shopping database corresponding to http://shopping.msn.com contains data for products belonging to a specific domain (e.g., shoes). The column values from the data store 440 are extracted as the data tokens for the domain. Some minor analysis on the data tokens may be performed to ensure that good quality tokens are used. Also, for tokens of the type price or number, regular expressions from the data token values seen in the database may be manually written.

Words act as modifiers only within a certain context and a certain domain. For example, the word ‘football’ is a modifier in the query ‘football shoes’, but is a key entity in the query ‘football matches’. Thus, while mining query logs for modifiers, the queries are filtered by the specific domain of interest.

In one implementation, domain specific filtering 112 is implanted as a lightweight classification tool. Each query is annotated using known data tokens present in it. For each data token matched in the query, the query-domain-score is incremented by a fixed value depending on the weight of the matched data token. For example, the weights for the data token classes for the domain of ‘shoes’ may be as follows: <product-class> 0.9, <shoe-brand> 0.8, <target-user> 0.1, <price> 0.2.

The query “womens athletic shoes under $40” can be annotated as “<target-user> athletic <product-class> under <price>”. The query-domain-score for this query is computed as 0.1 (for matched target-user)+0.9 (for matched product-class)+0.2 (for matched price)=1.1. When the query-domain-score exceeds a threshold of 1.0, the query is classified as specific to the “shoes” domain and used for modifier mining.

Each filtered query is annotated (block 113) using the list of known data tokens. New words found in query logs are maintained as candidate modifiers. For example, in the query “womens athletic shoes under $40” annotated as “<target-user> athletic <product-class> under <price>”, the words ‘athletic’ and ‘under’ are treated as candidate modifiers. The candidate modifiers with very low support (e.g., <0.002) are filtered out as noisy words, as the mechanism is interested in the more frequent modifiers used in queries.

For each candidate modifier, a data structure called the M-struct (also referred to as Token-Context) is generated, as represented by blocks 114 of FIG. 1 and block 413 of FIG. 4. In one implementation, the M-struct is represented using class TokenContext. A token acts as a modifier depending on its own token characteristics and the context in which the token is used. An M-struct captures these aspects for candidate modifiers. M-structs include two sets of features, namely token features 416 and context features 418.

Token features refer to the attributes of candidate modifiers that depend on the words representing the modifier. These are independent of the context in which the modifier occurs. Two token features are used in one implementation, including token part-of-speech, and token semantics.

The token part of speech feature captures the commonly used part-of-speech for the token, e.g., <athletic>: Adjective, or <under>: Preposition. This may be implemented using the known WordNet part-of-speech look-up function. While part-of-speech has is a reasonable modifier feature, finding the right part-of-speech for a word in a query is relatively difficult, and this feature may be quite noisy.

The token semantics feature is captured using ‘IS-A’ relationships among words, e.g., implemented as WordNet Hypernym Paths. For example, the word ‘athletic’ has hypernym paths as <athletic>: (related to):

sport, athletics

IS-A diversion, recreation

IS-A activity

IS-A act, human action/activity

IS-A event

IS-A psychological feature

IS-A abstraction

IS-A abstract entity

IS-A entity

Context features are attributes of a candidate modifier that depend on the context of usage of the modifier. These are independent of the token properties of the modifier. The context of a modifier may be defined as the known data tokens and other words with which it occurs in the query. Two context features include a data context vector feature and a prev-next context vector feature.

In general, the data context vector feature captures the order-independent context of a candidate modifier. It is represented as a TF-IDF (term frequency-inverse document frequency) vector for data token co-occurrence. For example, for the query “womens athletic shoes under $40.00”, annotated as “<target-user> athletic <product-class> under <price>”, the Data Context Vector for the candidate modifier ‘athletic’ comprises the co-occurring data tokens, i.e., {<target-user>,<product-class>,<price>}, represented as TF-IDF-like values.

The TF (term frequency) equivalent is the number of times the modifier candidate co-occurs with the same data token contexts. That is, if the candidate modifier ‘athletic’ co-occurs with the data tokens {<target-user>,<product-class>,<price>}, such as forty times in the query log, then the term frequency is forty (40).

To compute the IDF equivalent, each query is treated as a document. The total number of documents (independent queries) in which a data token occurs is called the document frequency of the data token (docFreq(token)). The IDF of a token is defined as 1/(1+log(1+docFreq(token))). For example, if the data token <product-class> occurs 30,000 times in the filtered query log, its IDF is 1/(1+log(1+30000))=0.1826. Similarly, if the data token <target-user> occurs 10000 times and <price> occurs 1000 times, their IDF values are 0.1999 and 0.2499 respectively. Note that because of the inverse relationship, the more frequent the data token in the query log, lower is its IDF.

The TF-IDF value is the product of the TF and IDF values. For example, the final TF-IDF vector for ‘athletic’ is {<target-user>:40*0.1999,<product-class>:40*0.1826,<price>:40*0.2499}

The TF-IDF representation is useful when computing similarity between two data context vectors. As the vectors have already accounted for frequency of co-occurrence as well as the global frequency of occurrence, similarity computation is as straightforward using cosine similarity.

The prev-next context vector feature captures the order-specific context of a candidate modifier. It is represented as a TF-IDF vector for a previous and next token. The TF-IDF values are computed similar to data context vector described above.

For example, for the query “womens athletic shoes under $40.00”, annotated as “<target-user> athletic <product-class> under <price>”, the prev-next context vector for the candidate modifier ‘athletic’ is {prev:<target-user>,next:<product-class>} represented as TF-IDF like values.

The TF (term frequency) equivalent is the number of times the token appears as the previous or next token for a modifier candidate. That is, if the token <target-user> occurs before, and token <product-class> occurs after candidate modifier ‘athletic’ fifty times, then the term frequency is fifty.

The IDF is computed in the same way as the above-described data context vector computation. For example, if the data token <product-class> occurs 30,000 times in the filtered query log, its IDF is 1/(1+log(1+30000))=0.1826. Similarly, if the data token <target-user> occurs 10000 times and <price> occurs 1000 times, their IDF values are 0.1999 and 0.2499 respectively. As can be seen, the more frequent the data token in the query log, the lower is its IDF.

The TF-IDF value of the prev-next context vector is the product of TF and IDF values. For example, the final TF-IDF prev-next context vector for ‘athletic’ is {prev:<target-user>:40*0.1999,next:<product-class>:40*0.1826}.

The previous-next context can be extended to include previous two and next two tokens, or in general, previous ‘k’ and next ‘k’ tokens. However, as typical queries are less than five words, an implementation using only one previous and one next token is generally sufficient.

Once the domain specific annotated queries are obtained, the candidate modifiers may be extracted represented using M-structs. The frequency of occurrence of identical M-structs is an indication of the popularity of the candidate modifier. Further, M-struct similarity somewhat captures the similarity in the role of the candidate modifiers, because similar M-structs imply similar token features (i.e. word characteristics) and similar context features (i.e. word usage).

With respect to M-struct similarity for generating dictionaries for candidate modifiers, a clustering based approach is adopted, as generally represented by blocks 115 and 116 of FIG. 1. The M-structs for candidate modifiers are clustered into the dictionaries 106₁-106_{N} with modifiers of similar functions. For example, modifiers used with price data, such as “below”, “less than” and “under” may be clustered together.

For clustering M-structs, similarity among M-structs is computed. In one implementation, the similarity between two M-structs m1 and m2 is defined as the weighted average similarity between their respective token features and context features (represented by block 420 of FIG. 4):

$$sim ( t 1 , t 2 ) = w 1 * POS \text{-} sim ( t 1 , t 2 ) + w 2 * Semantic \text{-} sim ( t 1 , t 2 ) + w 3 * DataContext \text{-} sim ( t 1 , t 2 ) + w 4 * PrevNext \text{-} sim ( t 1 , t 2 )$$

Example weights are w1=0.1, w2=0.3, w3=0.2, w4=0.4. As can be readily appreciated, various techniques for learning more exact weights may be used. As an example, to learn such weights, one learning mechanism may take a sample set of queries with their token-contexts and use labeled tags followed by a method such as logistic regression.

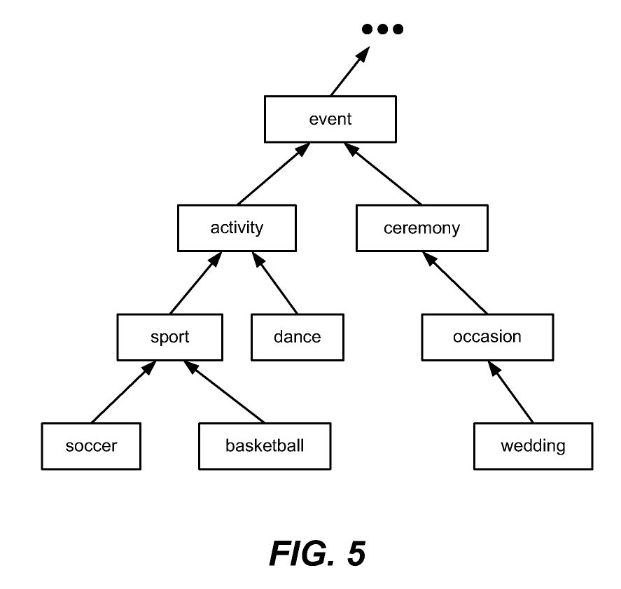

FIG. 5 represents semantic similarity between hypernym graphs. The similarity values are computed as:

POS-sim(t1, t2) = 1.0 if POS(t1.tok)==POS(t2.tok), or 0.0 otherwise.
Semantic-sim(t1,t2) = 2 * depth(LCS(t1.tok,t2.tok)) / (depth(t1.tok) +
depth(t2.tok))
where LCS = Least Common Ancestor (Wu & Palmer measure).
DataContext-sim(t1,t2) = Cosine similarity of Data Context vectors
PrevNext-sim(t1,t2) = Cosine similarity of Previous−Next Context vectors.

In general, clustering is performed based on structured related features. Note that while example features are described herein, in alternative implementations, not all of these example features need be used, and/or other features may be used instead of or in addition to these examples. Further, while one example clustering algorithm is described herein, any other suitable clustering algorithm may be used instead.

Example clustering pseudocode is set forth below:

```
// Main Function for clustering.
Function List<Cluster> ClusterModifier (List<MStruct> mStructList,
                int thresholdFreq,
                double clusteringCutoff)
    clusterList = InitClusters (mStructList, thresholdFreq)
    clusterList = FormClusters (clusterList, clusteringCutoff)
    return clusterList
--------------------------------------------------------------------
// Function for cluster list initialization.
// Create a cluster for each qualifying candidate modifier.
// Return a list of all clusters.
Function List<Cluster> InitClusters (List<MStruct> mStructList,
                int thresholdFreq)
    List<Cluster> clusterList = new List<Cluster>( );
    foreach (MStruct m in mStructList)
        if (m.frequency >= threshold Freq)
            Cluster c = new Cluster( );
            c.AddMember(m);
            clusterList.Add(c);
    return clusterList;
----------------------------------------------------------------------
// Function for actual clustering.
Function List<Cluster> FormClusters (List<Cluster> clusterList,
                double clusteringCutoff)
    // Compute similarity matrix with similarity values
    // for all cluster pairs
    foreach (Cluster c1 in clusterList)
        foreach (Cluster c2 in clusterList)
            if (c1.Id < c2.Id)
                similarityMatrix[c1.Id,c2.Id]
                    = ClusterSimilarity(c1, c2);
    // Perform actual clustering
    While (true)
        // If there is only 1 cluster, stop further clustering.
        If (numberMembers(cluster-list) < 2)
            Stop clustering, break;
        Find cluster pair (c1,c2) with max similarity
        // If max-similarity is below the clusteringCutoff,
        // stop further clustering
        If (max-similarity < clusteringCutoff)
            Stop clustering, break;
        Merge cluster c2 into c1
        Remove cluster c2 from clusterList
        Remove entries for c2 from similarityMatrix
        Recompute similarityMatrix entries for updated cluster c1
    // Clustering complete.
    // Compute cluster ranking metrics.
    Foreach (Cluster c in clusterList)
        Compute clusterSize (number of members in cluster c)
        Compute clusterSemanticSimilarity =
            ClusterSemanticSimilarity(c, c)
        Compute ranking factor as (log(clusterSize) *
                    clusterSemanticSimilarity)
    Sort clusterList by ranking factor
    Return clusterList;
------------------------------------------------------------------------
// Returns average weighted semantic similarity between
// M-struct members of the two clusters.
// If cluster c1 is the same as cluster c2, returns average cluster
// semantic similarity (cluster semantic cohesion).
Function double ClusterSemanticSimilarity (Cluster c1, Cluster c2)
    similarityNumerator = 0;
    similarityDenominator = 0;
    Foreach (mStruct m1 in c1.mStructList)
        Foreach (mStruct m2 in c2.mStructList)
            similarityDenominator += m1.frequency * m2.frequency;
            similarityNumerator
                += m1.frequency * m2.frequency *
                ComputeSemanticSimilarity(m1.token, m2.token);
    similarity = similarityNumerator/simlarityDenominator;
    return similarity;
------------------------------------------------------------------------
// Returns average weighted similarity between M-struct members
// of the two clusters.
// If cluster c1 is the same as cluster c2, returns average cluster
// similarity (cluster cohesion).
Function double ClusterSimilarity (Cluster c1, Cluster c2)
    similarityNumerator = 0;
    similarityDenominator = 0;
    Foreach (mStruct m1 in c1.mStructList)
        Foreach (mStruct m2 in c2.mStructList)
            similarityDenominator += m1.frequency * m2.frequency;
            similarityNumerator
                += m1.frequency * m2.frequency *
                  ComputeMStructSimilarity(m1, m2);
    similarity = similarityNumerator/simlarityDenominator;
    return similarity;
```

As can be seen, the clustering algorithm uses hierarchical agglomerative clustering for grouping M-structs into dictionaries. The clustering algorithm initializes a list of clusters (Function InitClusters) with each cluster containing exactly one candidate modifier or M-struct. Then, in the FormClusters function, the clustering algorithm computes the pair-wise similarity among all clusters and stores the results in a similarity matrix. The clustering algorithm picks the cluster pair with the maximum similarity and merges them into one cluster. The clustering algorithm then updates the similarity matrix to remove the older clusters and include the newly formed cluster. The algorithm uses pre-cached similarity values to avoid re-computation of similarities between cluster members. The algorithm continues cluster merging until the maximum similarity among cluster pairs is below the specified clustering cutoff, or when there is only one cluster left, with no more clustering to perform.

After completing the clustering, the clustering algorithm computes the semantic cohesion for each cluster, which is an average weighted semantic similarity among members of a cluster. The ranking metric that is used for finding the top clusters is (cluster semantic similarity*clusterSize). Similarity between two clusters is computed as the average weighted similarity between the members of two clusters (Function ClusterSimilarity). M-struct similarity is computed as described above.

In a post-processing step (represented by block 422 of FIG. 4), the clusters may be filtered by the significance of presence of the token in the cluster. For example, for a cluster member M-struct m, if m.frequency/m.token.frequency is very small (<0.01), the member m is removed from the cluster. Alternatively, the cluster can be filtered based on the top members of a cluster, e.g., for a cluster member M-struct m, if m.frequency/(Σ_{(iεcluster)} i.frequency) is very small (<0.01), the member is removed from the cluster.

### Exemplary Operating Environment

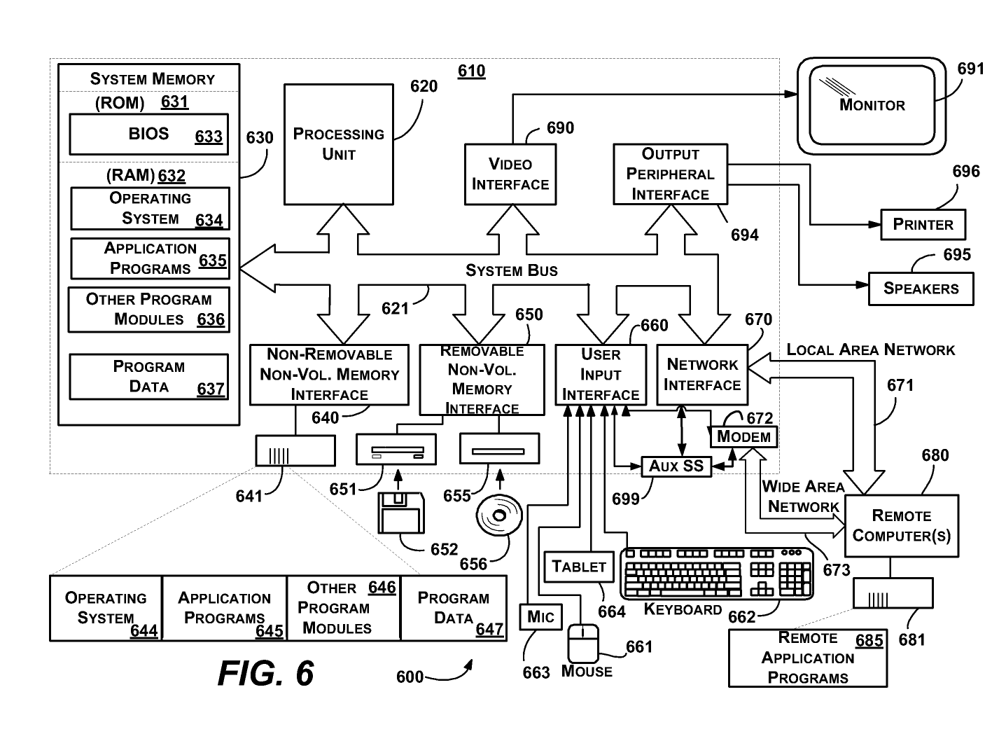

FIG. 6 illustrates an example of a suitable computing and networking environment 600 into which the examples and implementations of any of FIGS. 1-5 may be implemented. The computing system environment 600 is only one example of a suitable computing environment and is not intended to suggest any limitation as to the scope of use or functionality of the invention. Neither should the computing environment 600 be interpreted as having any dependency or requirement relating to any one or combination of components illustrated in the exemplary operating environment 600.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 6, an exemplary system for implementing various aspects of the invention may include a general purpose computing device in the form of a computer 610. Components of the computer 610 may include, but are not limited to, a processing unit 620, a system memory 630, and a system bus 621 that couples various system components including the system memory to the processing unit 620. The system bus 621 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 610 typically includes a variety of computer-readable media. Computer-readable media can be any available media that can be accessed by the computer 610 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 610. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The system memory 630 includes computer storage media in the form of volatile and/or nonvolatile memory such as read only memory (ROM) 631 and random access memory (RAM) 632. A basic input/output system 633 (BIOS), containing the basic routines that help to transfer information between elements within computer 610, such as during start-up, is typically stored in ROM 631. RAM 632 typically contains data and/or program modules that are immediately accessible to and/or presently being operated on by processing unit 620. By way of example, and not limitation, FIG. 6 illustrates operating system 634, application programs 635, other program modules 636 and program data 637.

The computer 610 may also include other removable/non-removable, volatile/nonvolatile computer storage media. By way of example only, FIG. 6 illustrates a hard disk drive 641 that reads from or writes to non-removable, nonvolatile magnetic media, a magnetic disk drive 651 that reads from or writes to a removable, nonvolatile magnetic disk 652, and an optical disk drive 655 that reads from or writes to a removable, nonvolatile optical disk 656 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 641 is typically connected to the system bus 621 through a non-removable memory interface such as interface 640, and magnetic disk drive 651 and optical disk drive 655 are typically connected to the system bus 621 by a removable memory interface, such as interface 650.

The drives and their associated computer storage media, described above and illustrated in FIG. 6, provide storage of computer-readable instructions, data structures, program modules and other data for the computer 610. In FIG. 6, for example, hard disk drive 641 is illustrated as storing operating system 644, application programs 645, other program modules 646 and program data 647. Note that these components can either be the same as or different from operating system 634, application programs 635, other program modules 636, and program data 637. Operating system 644, application programs 645, other program modules 646, and program data 647 are given different numbers herein to illustrate that, at a minimum, they are different copies. A user may enter commands and information into the computer 610 through input devices such as a tablet, or electronic digitizer, 664, a microphone 663, a keyboard 662 and pointing device 661, commonly referred to as mouse, trackball or touch pad. Other input devices not shown in FIG. 6 may include a joystick, game pad, satellite dish, scanner, or the like. These and other input devices are often connected to the processing unit 620 through a user input interface 660 that is coupled to the system bus, but may be connected by other interface and bus structures, such as a parallel port, game port or a universal serial bus (USB). A monitor 691 or other type of display device is also connected to the system bus 621 via an interface, such as a video interface 690. The monitor 691 may also be integrated with a touch-screen panel or the like. Note that the monitor and/or touch screen panel can be physically coupled to a housing in which the computing device 610 is incorporated, such as in a tablet-type personal computer. In addition, computers such as the computing device 610 may also include other peripheral output devices such as speakers 695 and printer 696, which may be connected through an output peripheral interface 694 or the like.

The computer 610 may operate in a networked environment using logical connections to one or more remote computers, such as a remote computer 680. The remote computer 680 may be a personal computer, a server, a router, a network PC, a peer device or other common network node, and typically includes many or all of the elements described above relative to the computer 610, although only a memory storage device 681 has been illustrated in FIG. 6. The logical connections depicted in FIG. 6 include one or more local area networks (LAN) 671 and one or more wide area networks (WAN) 673, but may also include other networks. Such networking environments are commonplace in offices, enterprise-wide computer networks, intranets and the Internet.

When used in a LAN networking environment, the computer 610 is connected to the LAN 671 through a network interface or adapter 670. When used in a WAN networking environment, the computer 610 typically includes a modem 672 or other means for establishing communications over the WAN 673, such as the Internet. The modem 672, which may be internal or external, may be connected to the system bus 621 via the user input interface 660 or other appropriate mechanism. A wireless networking component 674 such as comprising an interface and antenna may be coupled through a suitable device such as an access point or peer computer to a WAN or LAN. In a networked environment, program modules depicted relative to the computer 610, or portions thereof, may be stored in the remote memory storage device. By way of example, and not limitation, FIG. 6 illustrates remote application programs 685 as residing on memory device 681. It may be appreciated that the network connections shown are exemplary and other means of establishing a communications link between the computers may be used.

An auxiliary subsystem 699 (e.g., for auxiliary display of content) may be connected via the user interface 660 to allow data such as program content, system status and event notifications to be provided to the user, even if the main portions of the computer system are in a low power state. The auxiliary subsystem 699 may be connected to the modem 672 and/or network interface 670 to allow communication between these systems while the main processing unit 620 is in a low power state.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents failing within the spirit and scope of the invention.

What is claimed is:

1. In a computing environment, a method comprising, processing a query log of queries, including determining modifiers within at least some of the queries that provide information regarding targets, in which each target corresponds to a subset of structured data within a larger set of structured data, and the modifier for each target used to evaluate data within that subset.

2. The method of claim 1 wherein the set of structured data comprises a database table, wherein the subset of the structured data comprises a column of that table, and further comprising, processing a query having a modifier that corresponds to a target, including using the modifier to determine which rows of data in the column match the target.

3. The method of claim 1 wherein processing the query log of queries comprises filtering to obtain a subset of queries that correspond to a domain.

4. The method of claim 3 wherein processing the query log of queries comprises annotating each query in the subset based upon the data tokens within that query to find candidate modifiers for that query.

5. The method of claim 4 further comprising determining one or more sets of features for each candidate modifier.

6. The method of claim 4 further comprising determining a token part of speech feature and a token semantics feature for each candidate modifier.

7. The method of claim 4 further comprising determining one or more context features for each candidate modifier.

8. The method of claim 4 further comprising determining a context feature for each candidate modifier that is based upon usage frequency of the candidate modifier with respect to one or more other words in the queries.

9. The method of claim 4 further comprising determining a context feature for each candidate modifier that is based upon an ordering of the candidate modifier with respect to one or more other words in the queries.

10. The method of claim 4 further comprising, clustering candidate modifiers into dictionaries based upon one or more structured features representative of each candidate modifier.

11. The method of claim 10 further comprising, filtering candidate modifiers from the dictionaries based upon frequency.

12. In a computing environment, a system comprising, a set of dictionaries containing modifiers associated with a domain, the modifiers corresponding to tokens within queries, the modifiers associated with targets that map to columns of a data table corresponding to the domain, and the dictionaries accessible to process a query that maps to the data table and contains a modifier, including by evaluating data within a column in the table as determined from a target of the modifier.

13. The system of claim 12 wherein the modifiers include at least one dangling modifier that corresponds to a target that is not identified within the query, and at least one anchored modifier that corresponds to a target that is identified within the query.

14. The system of claim 12 wherein the modifiers include at least one subjective modifier having a plurality functions for evaluating a data column to which the corresponding target maps, and at least one objective modifier having a single function for evaluating a data column to which the corresponding target maps.

15. The system of claim 12 further comprising means for indicating an unobserved objective modifier, in which the unobserved objective modifier is in a query but does not have data in a data column to which the corresponding target maps.

16. The system of claim 12 wherein the dictionaries are automatically generated or manually provided, or wherein some of the dictionaries are automatically generated and some of the dictionaries are manually provided.

17. In a computing environment, a method comprising, processing an online search query that maps to a table, including determining whether the query includes a modifier of a target that corresponds to a column of that table, and if so, accessing the table and evaluating data in the column based upon the modifier to return results for the query from the table.

18. The method of claim 17 wherein determining whether the query includes a modifier comprises accessing one or more dictionaries of modifiers associated with that table.

19. The method of claim 17 wherein the modifier comprises a subjective modifier, and wherein evaluating data in the column comprises using a plurality of functions to determine which data in the column matches the subjective modifier.

20. The method of claim 17 wherein the query does not include a modifier of a target that corresponds to a column of that table, and further comprising, providing the query to a search engine to return the results.
